(19) United States
(12) Patent Application Publication
(10) Pub. No.: US 2023/0053596 A1
(43) Pub. Date: Feb. 23, 2023

(54) MOTOR, DISK DRIVE DEVICE, AND MANUFACTURING METHOD OF MOTOR

(71) Applicant: NIDEC CORPORATION, Kyoto (JP)

(72) Inventor: Shingo KAKITA, Kyoto (JP)

(21) Appl. No.: 17/888,479

(22) Filed: Aug. 16, 2022

(30) Foreign Application Priority Data
Aug. 18, 2021 (JP) 2021-133223

(51) Int. Cl. G11B 19/20; G11B 25/04; G11B 5/48

(52) U.S. Cl. CPC G11B 19/2009; G11B 25/043; G11B 5/4813

(57) ABSTRACT

A motor includes a rotor, a stator, a shaft, a base part, a hole part, a connector, and a metal connection portion. The rotor is rotatable about the axial direction. The stator radially opposes the rotor. The shaft extends axially along the central axis and supports the rotor. The base part is disposed on axial one side relative to the stator, and radially expands from the shaft. The hole part axially penetrates the base part. The connector covers the hole part when viewed from the axial direction. The metal connection portion connects the connector to the base part. The metal connection portion is disposed between the base part and the connector in the axial direction, and surrounds the hole part when viewed from the axial direction.

### CROSS-REFERENCE TO RELATED APPLICATIONS

The present invention claims priority under 35 U.S.C. § 119 to Japanese Patent Application No. 2021-133223 filed on Aug. 18, 2021, the entire content of which is incorporated herein by reference.

### FIELD OF THE INVENTION

The present disclosure relates to a motor, a disk drive device, and a manufacturing method of a motor.

### BACKGROUND

Conventionally, a disk drive device that reduces fluid resistance during disk rotation by sealing a low-density gas is known. This disk drive device includes a connector for connecting an internal device to the outside. The connector is connected to a base member of a spindle motor via, for example, an epoxy or acrylic adhesive. The center of the connector opposes a through hole formed in the base member. The adhesive is filled in a gap formed around the through hole over the entire circumference and seals the gap.

However, when the connector and the base member are bonded and sealed with a resin adhesive, the adhesive may be cracked or peeled off due to thermal expansion of the connector and the base member under a temperature stress environment. In this case, there is a possibility that the adhesive strength of the connector with respect to the base member decreases. Furthermore, there is also a possibility that sealing between both becomes insufficient and the airtightness decreases.

### SUMMARY

A motor according to an exemplary example of the present disclosure includes a rotor, a stator, a shaft, a base part, a hole part, a connector, and a metal connection portion. The rotor is rotatable about an axial direction. The stator opposes the rotor in the radial direction. The shaft extends in an axial direction along a central axis and supports the rotor. The base part is disposed on axial one side relative to the stator, and expands in the radial direction from the shaft. The hole part penetrates the base part in the axial direction. The connector covers the hole part as viewed in the axial direction. The metal connection portion connects the connector to the base part. The metal connection portion is disposed between the base part and the connector in the axial direction and surrounds the hole part when viewed from the axial direction.

A disk drive device according to an exemplary example of the present disclosure includes the above-described motor and an access portion. The access portion performs at least any of reading and writing of information on a disk supported by the motor.

A manufacturing method of the motor according to an exemplary example of the present disclosure includes steps of: disposing a paste substance containing metal nanoparticles and a dispersion medium in a region outside relative to an outer edge part of an axial end part of the hole part; covering the hole part with the connector by disposing the connector at an axial end part of the base part with the paste substance interposed therebetween; and forming the metal connection portion by burning the paste substance.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a configuration example of a disk drive device;

FIG. 2 is a plan view of an end part on an axial one side of the disk drive device;

FIG. 3 is an enlarged cross-sectional view of the vicinity of a connector;

FIG. 4 is a cross-sectional view illustrating another arrangement example of the connector; and

FIG. 5 is a flowchart for explaining an attachment process of the connector using a metal connection portion.

### DETAILED DESCRIPTION

An exemplary embodiment will be described with reference to the drawings.

In the present description, in a disk drive device 100 and a motor 1, a direction parallel to a central axis CX is referred to as “axial”. A direction orthogonal to a predetermined axis such as the central axis CX is referred to as “radial”, and a rotation direction about the predetermined axis is referred to as “circumferential”.

In the positional relationship between any of a cardinal direction, a line, and a plane and another of them, the term “parallel” includes not only a state in which the both do not intersect at any point but also a state in which they are substantially parallel. The terms “perpendicular” and “orthogonal” include not only a state in which the both intersect each other at 90 degrees, but also a state in which they are substantially perpendicular and a state in which they are substantially orthogonal. That is, the terms “parallel”, “perpendicular”, and “orthogonal” each include a state in which the positional relationship of the both permits an angular deviation to a degree not departing from the gist of the present disclosure.

These are merely names used for description, and are not intended to limit actual positional relationships, directions, names, and the like.

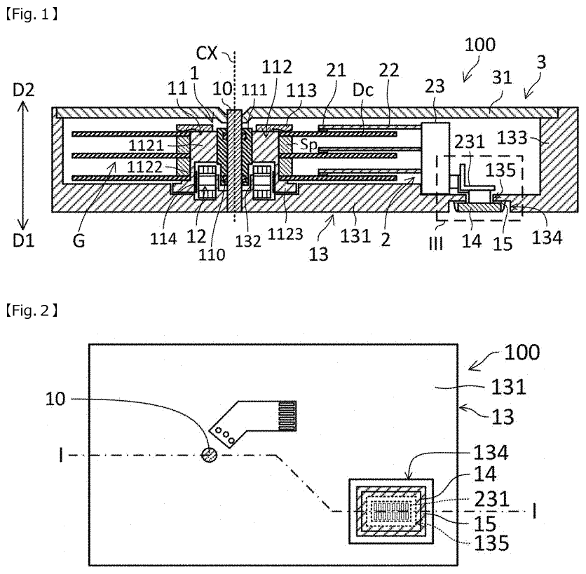

FIG. 1 is a cross-sectional view illustrating a configuration example of the disk drive device 100. FIG. 2 is a plan view of an end part of the disk drive device 100 on an axial one side D1. FIG. 1 illustrates a cross-sectional structure of the disk drive device 100 taken along a virtual plane including the central axis CX and expanding along an alternate long and short dash line I-I in FIG. 2. FIG. 2 illustrates the disk drive device 100 viewed from the axial one side D1 to an axial other side D2.

The disk drive device 100 of the present embodiment is a hard disk drive. The disk drive device 100 includes a motor 1 and an access portion 2. The disk drive device 100 further includes a top plate part 31 and a disk Dc. The motor 1 supports the disk Dc and rotationally drives the disk Dc about the central axis CX. The access portion 2 performs at least any of reading and writing of information on the disk Dc. As described later, in the disk drive device 100 of the present embodiment, by connecting a base part 13 of the motor 1 and a connector 14 by a metal connection portion 15, it is possible to improve the strength and airtightness of a connection part of the connector 14 with respect to the base part 13 as compared with a resin adhesive member.

The access portion 2 includes a plurality of heads 21, a plurality of arms 22, and a head movement mechanism 23. The head 21 approaches the surface of the disk Dc, and magnetically performs at least any one of reading of information recorded on the disk Dc and writing of information to the disk Dc. The head 21 is disposed at one end part of the arm 22 on the motor 1 side and is supported by the arm 22. The other end part of the arm 22 is supported by the head movement mechanism 23.

The top plate part 31 constitutes a housing 3 of the disk drive device 100 together with the base part 13 of the motor 1 (particularly, a bottom plate part 131 and a side plate part 133 described later). The disk drive device 100 includes the housing 3. The housing 3 accommodates the disk Dc, the motor 1, and the access portion 2. The present invention is not limited to the example of the present embodiment, and the bottom plate part of the housing 3 and the side plate part extending from the bottom plate part in the axial other side D2 and surrounding the motor 1 and the access portion 2 may be members different from the base part 13 of the motor 1. The top plate part 31 expands in a direction perpendicular to the central axis CX and covers an opening (reference numeral omitted) at an end part of the base part 13 on the axial other side D2 side. The top plate part 31 is connected to the base part 13 so that airtightness in the housing 3 is not impaired. For example, the top plate part 31 is fitted into the opening of the base part 13 with a sealing member (not illustrated) interposed therebetween such as a metal gasket and is connected to the side plate part 133. The outer edge part of the top plate part 31 can be connected to the side plate part 133 by a connection means such as welding or brazing.

The top plate part 31 forms a sealed space inside the housing 3 together with the base part 13 of the motor 1. The housing 3 (that is, the above-described sealed space) is filled with a gas G having a density lower than that of air. Helium gas is used as the gas G in the present embodiment. However, the gas G is not limited to this example, and a hydrogen gas, a mixed gas of He and H₂, or the like may be used as the gas G. This makes it possible to reduce fluid resistance acting on the disk Dc and a rotor 11 described later at the time of rotationally driving the motor 1 and the disk Dc.

The disk Dc is a medium on which information is recorded. In the present embodiment, the number of disks Dc is three as illustrated in FIG. 1, but is not limited to this example. The number of disks Dc may be singular or plural other than three. The disk Dc is disposed on a radially outer surface of the rotor 11 of the motor 1, and is stacked in the axial direction with a spacer Sp interposed therebetween.

The disk Dc of the present embodiment is a magnetic recording medium and is accommodated inside the sealed housing of the disk drive device 100. However, the disk Dc is not limited to the example of the present embodiment. For example, the disk Dc may be an optical recording medium such as a digital versatile disk (DVD) or a Blu-ray disk (BD: registered trademark), or may be accommodated in the housing 3 so as to be able to be taken in and out. That is, the disk drive device 100 may be a DVD player, a BD player, a DVD recorder, a BD recorder, or the like.

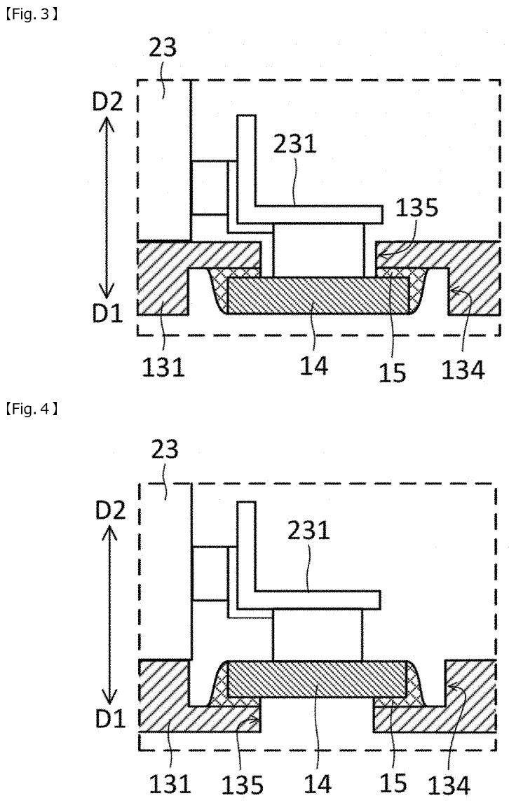

The configuration of the motor 1 will be described with reference to FIGS. 1 to 4. FIG. 3 is an enlarged cross-sectional view of the vicinity of the connector 14. FIG. 4 is a cross-sectional view illustrating another arrangement example of the connector 14. FIG. 3 is an enlarged view of a part III surrounded by a broken line in FIG. 1. FIG. 4 corresponds to a part III surrounded by the broken line in FIG. 1.

The motor 1 is a direct-current spindle motor in the present embodiment. The motor 1 includes a cylindrical shaft 10, the rotor 11, a stator 12, the base part 13, the connector 14, and the metal connection portion 15.

The shaft 10 extends axially along the central axis CX and rotatably supports the rotor 11 about the central axis CX. As described above, the motor 1 includes the shaft 10. The shaft 10 is formed of, for example, metal such as stainless steel. The end part of the shaft 10 on the axial one side D1 is coupled to the base part 13. The end part of the shaft 10 on the axial other side D2 side is fixed to the top plate part 31 of the housing 3.

The rotor 11 is rotatable about the central axis CX. As described above, the motor 1 includes the rotor 11. The rotor 11 includes a sleeve 111, a rotor hub 112, a clamp member 113, and a magnet 114.

The sleeve 111 has a tubular shape surrounding the central axis CX and extends in the axial direction. Inside the sleeve 111, a bearing 110 is disposed, and the shaft 10 is inserted. The sleeve 111 is rotatably supported about the central axis CX by the shaft 10 and the bearing 110. The bearing 110 is a fluid dynamic bearing in the present embodiment. Specifically, the sleeve 111 radially opposes the shaft 10 and has a gap therebetween. This gap is filled with fluid (not illustrated) such as lubricating oil or gas. However, the present invention is not limited to this example, and the bearing 110 may be another bearing such as a ball bearing.

The rotor hub 112 is fixed to the radially outer end part of the sleeve 111 and is rotatable about the central axis CX together with the sleeve 111. The rotor hub 112 may be integral with or separate from the sleeve 111. As a material of the sleeve 111 and the rotor hub 112, for example, a metal material such as aluminum, its alloy, or stainless steel is used. The rotor hub 112 includes an annular part 1121, a tube part 1122, and a flange part 1123. The annular part 1121 extends radially outward from the radially outer end part of the sleeve 111. The tube part 1122 has a tubular shape extending in the axial one side D1 from the radially outer end part of the annular part 1121, and is disposed radially outward relative to the stator 12. The flange part 1123 extends radially outward from the end part of the tube part 1122 on the axial one side D1.

As illustrated in FIG. 1, the clamp member 113 supports the disk Dc together with the flange part 1123 of the rotor hub 112. Specifically, the radially inner end part of the clamp member 113 is supported by the annular part 1121 of the rotor hub 112. The clamp member 113 sandwiches the disk Dc stacked with the spacer Sp interposed therebetween with the flange part 1123 in the axial direction.

The magnet 114 is fixed to the inner peripheral surface of the tube part 1122 of the rotor hub 112. The magnet 114 has an annular shape surrounding the central axis CX. The inner peripheral surface of the magnet 114 is a magnetic pole surface in which N poles and S poles are alternately arrayed along the circumferential direction. The magnet 114 may be directly fixed to the rotor hub 112, or may be fixed to the rotor hub 112 with a yoke made of a magnetic material interposed therebetween.

The stator 12 has an annular shape surrounding the shaft 10 and is disposed on the axial other side D2 relative to the base part 13. The stator 12 is supported by the base part 13. As described above, the motor 1 includes the stator 12. The stator 12 radially opposes the magnet 114 of the rotor 11, and rotates the rotor 11 in accordance with supply of electric power.

The base part 13 is disposed on the axial one side D1 relative to the stator 12 and expands in the radial direction from the shaft 10. As described above, the motor 1 includes the base part 13. The base part 13 is molded by casting, for example, and is die-cast aluminum in the present embodiment.

The base part 13 includes the bottom plate part 131, a holder part 132, and the side plate part 133. The bottom plate part 131 is disposed on the axial one side D1 relative to the disk Dc, the motor 1, and the access portion 2, and expands in a direction intersecting the central axis CX. The holder part 132 has a tubular shape surrounding the central axis CX and extends in the axial other side D2 from the bottom plate part 131. The stator 12 is fixed to the radially outer end part of the holder part 132. The side plate part 133 extends in the axial other side D2 from the outer edge part of the bottom plate part 131 when viewed from the axial direction and surrounds the disk Dc, the motor 1, and the access portion 2. The side plate part 133 is integrated with the bottom plate part 131 in the present embodiment, but is not limited to this example, and may be a separate body from the bottom plate part 131. The side plate part 133 is connected to the bottom plate part 131 so that airtightness in the housing 3 is not impaired.

A recess part 134 and a hole part 135 are formed in the bottom plate part 131. The recess part 134 is disposed at an end part on the axial one side D1 of the bottom plate part 131 and is recessed in the axial other side D2. The hole part 135 axially penetrates the bottom plate part 131 and is continuous to the bottom surface of the recess part 134. The motor 1 includes the hole part 135. The hole part 135 is preferably disposed near the head movement mechanism 23.

The connector 14 is a connection terminal for electrically connecting a device (for example, the motor 1, the access portion 2, and the like) accommodated in the housing 3 to the outside of the disk drive device 100, and is fixed to the base part 13. For example, wiring to the outside is connected to the axial one side D1 of the connector 14. A connector 231 of the head movement mechanism 23 is coupled to the axial other side D2 of the connector 14. Due to this, the head movement mechanism 23 is electrically connected to the outside of the disk drive device 100. For example, the disk drive device 100 can send a signal read by the head 21 from the head movement mechanism 23 to a control unit (not illustrated) existing outside the housing 3 via the connector 231 and the connector 14. The disk drive device 100 can send a signal to be written by the head 21 from the above-described control unit to the head movement mechanism 23 via the connector 14 and the connector 231.

The connector 14 covers the hole part 135 when viewed from the axial direction. As described above, the motor 1 includes the connector 14. In the present embodiment, the connector 14 is accommodated in the recess part 134 and connected to the bottom surface of the recess part 134 by the metal connection portion 15. Specifically, as illustrated in FIG. 3, the connector 14 is connected to a continuous region along the outer edge part of the end part on the axial one side D1 of the hole part 135.

However, the present invention is not limited to this example, and the connector 14 may be fixed to the end part on the axial other side D2 side of the base part 13, and may be connected to, for example, a continuous region along the outer edge part of the end part on the axial other side D2 side of the hole part 135 (see FIG. 4).

The metal connection portion 15 connects the connector 14 to the base part 13. The base part 13 of the motor 1 includes the metal connection portion 15. The metal connection portion 15 is disposed between the base part 13 and the connector 14 in the axial direction, and surrounds the hole part 135 when viewed from the axial direction. Thus, the base part 13 and the connector 14 can be connected more firmly and without a gap. For example, when the both are connected by a resin adhesive member, the adhesive member may be cracked or peeled off due to thermal expansion of the base part 13 and the connector 14 due to temperature change. Since the resin easily permeates gas as compared with metal, it is difficult to maintain airtightness. Therefore, the connection strength and airtightness of the connection part of the connector 14 can be improved more by connecting the both with the metal member than by doing so with the resin adhesive member.

The metal connection portion 15 is disposed along all outer edge parts at the axial end part of the hole part 135. In the present embodiment, the metal connection portion 15 is disposed in a continuous region along the outer edge part of the end part on the axial one side D1 of the hole part 135 on one axial end part end surface of the base part 13. This makes it possible to connect the connector 14 to the base part 13 without a gap along the outer edge part described above. Therefore, it is possible to secure airtightness at the connection part between the both.

Preferably, the metal connection portion 15 covers at least a part of the side surface of the connector 14. This allows the connector 14 to be more firmly connected to the base part 13. However, this example does not exclude a configuration in which the metal connection portion 15 does not cover the side surface of the connector 14.

For the metal connection portion 15, for example, silver, copper, gold, or an alloy of them can be used. Preferably, the material of the metal connection portion 15 is silver. This makes it possible to improve cost effectiveness regarding the formation of the metal connection portion 15. For example, by adopting silver, it is possible to improve durability (for example, corrosion resistance) of the metal connection portion 15 more than that in a case of adopting copper (or copper alloy). For example, since the manufacturing cost of the metal connection portion 15 can be reduced more than that in a case of adopting gold (or gold alloy) or the like, the productivity of the motor 1 can be improved. However, the above-described examples do not exclude a configuration in which metal materials other than silver, copper, gold, and alloys of them are adopted.

In the present embodiment, the metal connection portion 15 is a dense burned substance of metal nanoparticles. The formation of the metal connection portion 15 will be described later.

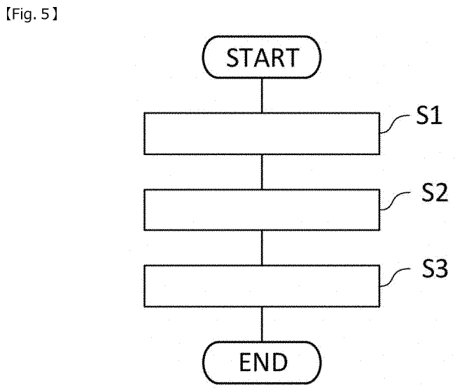

An attachment method of the connector 14 using the metal connection portion 15 will be described with reference to FIGS. 1, 2, and 5. FIG. 5 is a flowchart for explaining the attachment process of the connector 14 using the metal connection portion 15.

A paste substance to be a precursor of the metal connection portion 15 is applied to the base part 13 (step S1). In the present embodiment, the paste substance is a silver nanoparticle paste, and is applied to a continuous region along the outer edge part at the end part on the axial one side D1 of the hole part 135. In the silver nanoparticle paste, nanosized silver particles are dispersed in a dispersion medium.

The connector 14 is disposed on the base part 13 (step S2). The connector 14 is disposed in the above-described continuous region with the applied paste substance interposed therebetween, and covers the entire end part on the axial one side D1 of the hole part 135.

The paste substance is burned together with the base part 13 of the motor 1 (step S3). The paste substance can be burned at, for example, equal to or higher than 150° C. and equal to or lower than 330° C., and is burned at 240° C. in the present embodiment. The burning temperature is only required to be a temperature at which the dispersion medium is vaporized and the silver nanoparticles can be melted. Due to this burning, the metal connection portion 15 is formed, and the connector 14 can be densely and firmly connected to the base part 13.

The attachment process in FIG. 5 is a part of the manufacturing process of the motor 1. That is, the manufacturing method of the motor 1 includes steps S1, S2, and S3 described above. In step S1, a paste substance containing metal nanoparticles and a dispersion medium is disposed in a region outside relative to the outer edge part of the axial end part of the hole part 135. In step S2, the hole part 135 is covered with the connector 14 by disposing the connector 14 at the axial end part of the base part 13 with the paste substance interposed therebetween. In step S3, the metal connection portion 15 is formed by burning the paste substance.

When the paste substance is burned, the melting point of the metal nanoparticles greatly decreases due to a drop in melting point accompanying a decrease in particle size. Therefore, in the above-described manufacturing method, it is possible to form the metal connection portion 15 for connecting the connector 14 to the base part 13 by burning the paste substance at a temperature significantly lower than the original melting point (for example, 961.8° C. for silver) of the metal to be the material of the metal nanoparticles.

In step S1 of arranging the paste substance, the mean particle diameter of the metal nanoparticle is preferably equal to or less than 10 nm. The particle size of the metal nanoparticles can be measured using, for example, a transmission electron microscope (TEM), a scanning electron microscope (SEM), a scanning tunneling microscope (STM), an atomic force microscope (AFM), or the like. This makes it possible to form the metal connection portion 15 at a burning temperature equal to or lower than a heat-resistant temperature of the connector 14 or a substrate (not illustrated) burned together with the connector 14.

The present disclosure is useful for a device in which a connector is attached to a hole part of a housing, for example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about an axial direction;
a stator radially opposing the rotor;
a shaft axially extending along a central axis and supporting the rotor;
a base part disposed on axial one side relative to the stator and radially expanding from the shaft;
a hole part axially penetrating the base part;
a connector covering the hole part when viewed from an axial direction; and
a metal connection portion connecting the connector to the base part, wherein
the metal connection portion is disposed between the base part and the connector in an axial direction and surrounds the hole part when viewed from an axial direction.

2. The motor according to claim 1, wherein
the metal connection portion is disposed along all outer edge parts at an axial end parts of the hole part.

3. The motor according to claim 1, wherein
the metal connection portion covers at least a part of a side surface of the connector.

4. The motor according to claim 1, wherein
a material of the metal connection portion is silver.

5. A disk drive device comprising:
the motor according to claim 1; and
an access portion performing at least any of reading and writing of information on a disk supported by the motor.

6. The disk drive device according to claim 5 further comprising:
a housing accommodating the motor, the disk, and the access portion, wherein
the housing is filled with a gas having a density lower than a density of air.

7. A manufacturing method of a motor comprising steps of:
disposing a paste substance containing metal nanoparticles and a dispersion medium in a region outside relative to an outer edge part of an axial end part of the hole part;
covering the hole part with the connector by disposing the connector at an axial end part of the base part with the paste substance interposed therebetween; and
forming the metal connection portion by burning the paste substance.

8. The manufacturing method of a motor according to claim 7, wherein
in the step of disposing the paste substance, a mean particle diameter of the metal nanoparticles is equal to or less than 10 nm.
